(19) United States
(12) Patent Application Publication
(10) Pub. No.: US 2025/0259054 A1
(43) Pub. Date: Aug. 14, 2025

(54) SYSTEMS AND METHODS FOR A UNIFIED TRAINING FRAMEWORK OF LARGE LANGUAGE MODELS

(71) Applicant: Salesforce, Inc., San Francisco, CA (US)

(72) Inventors: Jianguo Zhang, San Jose, CA (US); Tian Lan, San Francisco, CA (US); Rithesh Murthy, San Francisco, CA (US); Zhiwei Liu, Palo Alto, CA (US); Weiran Yao, Palo Alto, CA (US); Juntao Tan, San Francisco, CA (US); Shelby Heinecke, San Francisco, CA (US); Yihao Feng, Austin, TX (US); Huan Wang, Palo Alto, CA (US); Juan Carlos Niebles, Mountain View, CA (US); Silvio Savarese, Palo Alto, CA (US); Caiming Xiong, Menlo Park, CA (US)

(21) Appl. No.: 18/658,899

(22) Filed: May 8, 2024

Related U.S. Application Data
(60) Provisional application No. 63/552,164, filed on Feb. 11, 2024.

(51) Int. Cl. G06N 3/08

(52) U.S. Cl. CPC G06N 3/08

(57) ABSTRACT

Embodiments described herein provide a unified LLM training pipeline that hands the diversity of various data structures and formats involving LLMs agent trajectories. These pipelines are specifically designed to transform incoming data into a standardized representation, ensuring compatibility across varied formats. Furthermore, the data collection undergoes a filtering process to ensure high-quality trajectories, adding an additional layer of refinement to the dataset. In this way, the training pipeline not only unifies trajectories across environments but also enhances the overall quality and reliability of the collected data for LLM training.

### CROSS REFERENCE(S)

The instant application is a nonprovisional of and claims priority under 35 U.S.C. 119 to U.S. provisional application No. 63/552,164, filed Feb. 11, 2024, which is hereby expressly incorporated by reference herein in its entirety.

### TECHNICAL FIELD

The embodiments relate generally to neural networks and machine learning systems, and more specifically to a unified training framework for large language models (LLMs).

### BACKGROUND

LLMs have been widely used as conversational agents in a variety of applications, such as information technology support, customer service, education, and/or the like. However, training LLMs for various tasks can be challenging because of various non-standardized data formats sourced from diverse dataset collections, especially those featuring interactions of multi-turns, as commonly observed in agent-relevant data. The heterogeneity in data structures, syntaxes, labeling conventions, and processing methods across datasets poses significant challenges, complicating the training and fine-tuning processes of LLMs.

### BRIEF DESCRIPTION OF THE DRAWINGS

FIG. 1 is a simplified diagram illustrating an example architecture of a neural network training pipeline, according to embodiments described herein.

FIGS. 2A-2B provide a simplified diagram illustrating an example process of generating a training dataset for a hardware training platform of neural networks from heterogeneous multi-turn data, according to embodiments described herein.

FIGS. 3A-3B are example heterogeneous data records that are transformed into a homogeneous format as an agent trajectory, according to embodiments described herein.

FIG. 4 is an example diagram illustrating an example prompt for an LLM to generate a rating given an input of agent trajectory, according to embodiments described herein.

FIG. 5 is a simplified diagram illustrating a computing device implementing the LLM training pipeline framework described in FIGS. 1-4, according to one embodiment described herein.

FIG. 6 is a simplified diagram illustrating the neural network structure implementing the LLM training pipeline module described in FIG. 5, according to some embodiments.

FIG. 7 is a simplified block diagram of a networked system suitable for implementing the LLM training pipeline framework described in FIGS. 1-4 and other embodiments described herein.

FIG. 8 is an example logic flow diagram illustrating an example method of training an intelligent agent for carrying out actions in response to user interactions, according to embodiments described herein.

FIGS. 9A-9B are example diagrams illustrating example pseudo code segments for implementing the method shown in FIG. 8, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

In view of the need for an improved training framework for LLMs on different datasets of diverse data formats, embodiments described herein provide a unified LLM training pipeline that trains an LLM using diverse training data having different data structures and formats on different tasks. Specifically, diverse training data involving different types of multi-turn interactions and/or executions may be transformed to a homogeneous multi-turn data format representing a user-agent interaction record (referred to as “trajectory”). A neural network based rating model may then rate each agent trajectory. Based on the ratings, a customized training dataset may be generated by sampling agent trajectories. The customized training datasets are then loaded to train the LLM.

In one embodiment, the training pipeline may transform incoming data into a homogeneous representation, ensuring compatibility across varied formats. Furthermore, the data collection undergoes a filtering process based on the rating of each training trajectory to ensure high-quality trajectories, adding an additional layer of refinement to the dataset. In this way, agent trajectories across environments may be efficiently used in training a neural network model such as an LLM in one training process or one training epoch, instead of multiple training processes that cost significant computational resources. With the computationally efficient training pipeline, neural network models can be trained using a large amount of diverse datasets to improve performance. Neural network technology is thus improved.

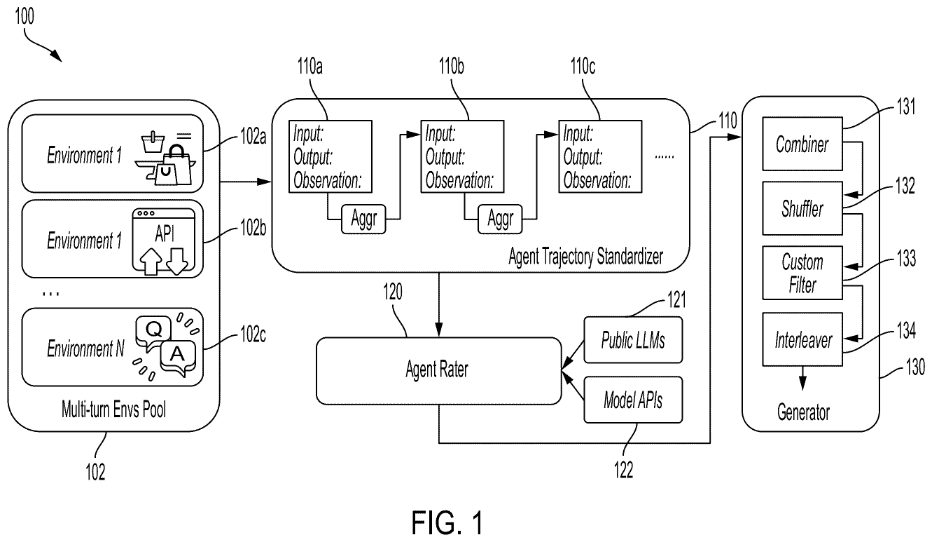

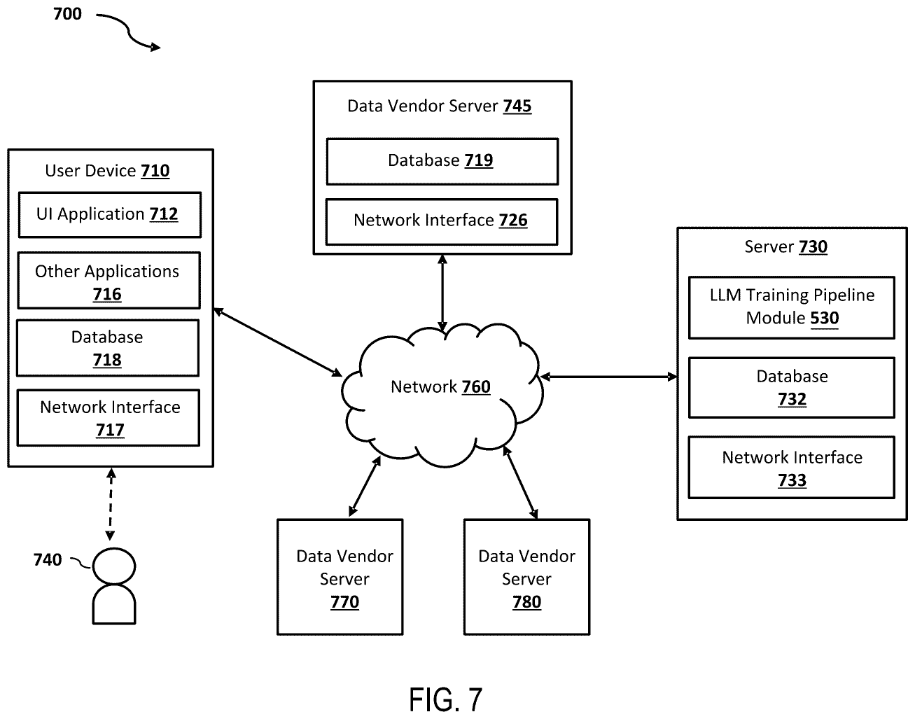

FIG. 1 is a simplified diagram illustrating an example architecture of a neural network training pipeline 100, according to embodiments described herein. In one embodiment, neural network training pipeline 100 may comprise an agent trajectory standardizer 110, an agent rater 120, and a training data generator 130. In one embodiment, agent trajectory standardizer 110, agent rater 120, and training data generator 130. In one embodiment, one or more of the agent trajectory standardizer 110, the agent rater 120, and the training data generator 130 may comprise one or more neural network models that are housed at the same or different servers. For example, the agent trajectory standardizer 110 may be housed at one of data vendor servers 745, 770 or 780 as shown in FIG. 7, while agent rater 120, and the training data generator 130 may be situated at server 730 in FIG. 7.

In one embodiment, raw data in multi-turn environments 102 from heterogeneous data sources, such as an electronic commerce website activity log 102a, an application programming interface (API) data activity log 102b, a user-agent question and answering conversation 102c, and/or the like, may be received.

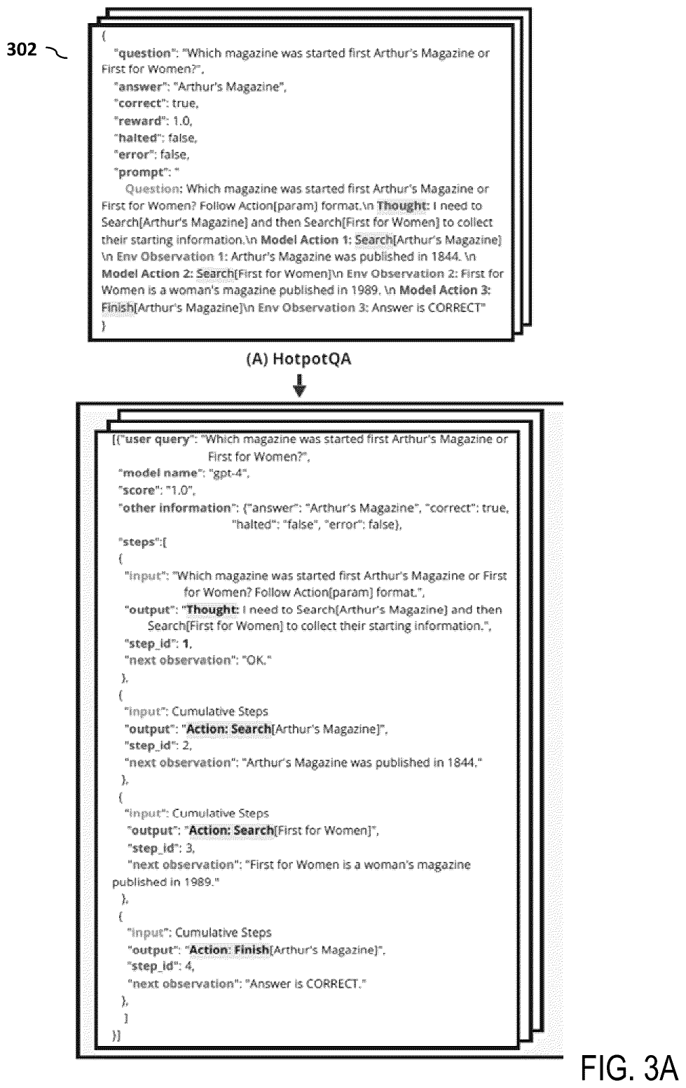

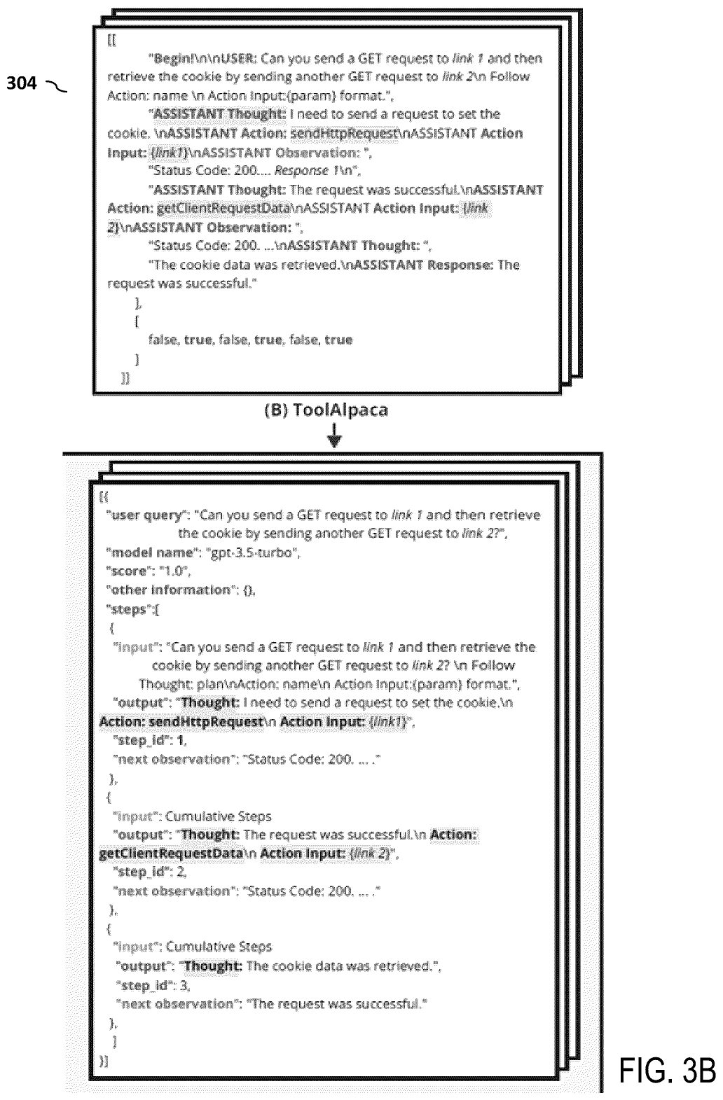

The formats of agent data 102a-c may vary significantly across different environments, posing significant difficulties and challenges in unifying data, training, and analyzing neural network models. For example, as shown in FIGS. 3A-3B, trajectories 302 and 304 from two distinct environments show different data formats different environments.

With reference back to FIG. 1, such trajectories 102a-c of different formats from heterogeneous data sources may be converted into a homogeneous multi-turn data format. In one embodiment, the agent trajectory standardizer 110 may construct a homogeneous JSON dictionary format to encapsulate all relevant content of each trajectory 102a-c. For example, such format incorporates all important elements such as user query to store the initial user query, model name to identify the corresponding model and score to log the available model performance score. These elements can be used to differentiate between models and are poised to facilitate the development of pairwise samples for training methodologies such as DPO (Rafailov et al., 2023), self-reward (Yuan et al., 2024) and AI feedback (Guo et al., 2024) LLMs.

In one embodiment, the homogenous format further comprise an “other information” segment. Auxiliary trajectory information or specific notes are saved into other information, providing a reference for further analysis or model improvement initiatives.

In one embodiment, the homogenous format may comprise a “step” segment that captures the details of each interaction turn. A step such as 110a-110c comprises three main components: input, output, and next observation. The input component consolidates the current prompt and a historical record of past interactions, serving as a comprehensive context for the interaction. The output component captures the model's predictions, detailing its decision-making and planning. The next observation component records the environment's feedback, essential for the feedback loop and system adaption.

In one embodiment, interaction history may be aggregated within the input component, effectively concatenating inputs and outputs from previous steps to construct a comprehensive context. Specifically, at the i^{th} step, the input is formatted as input of step 1, Action: output of step 1, Observation: next observation of step 1, . . . , input of step i−1, Action: output of step i−1, Observation: next observation of step i−1. In this way, a detailed chronological account of interactions is constructed, facilitating a nuanced understanding of the trajectory.

In one embodiment, other customization of data compilation methods may be applied to aggregates interaction steps 110a-c.

The challenge with agent trajectories extends to the evaluation of performance and quality. While some environments offer rewards as feedback for an agent's trajectory, such rewards are often tied to the task's final outcome rather than reflecting the quality of the trajectory itself. Consequently, a high reward does not necessarily indicate a flawless trajectory. For example, an agent might generate invalid actions during intermediate steps of a task. Here is partial trajectory from the Webshop environment (Yao et al., Webshop: Towards scalable real-world web interaction with grounded language agents, Advances in Neural Information Processing Systems, 35:20744-20757, 2022): model output of step 4: “click [old world style]”, observation of step 4: “You have clicked old world style.”; model output of step 5: “click [rope sausage]”, observation of step 5: “Invalid action!”; model output of step 6: “”, observation of step 6: “Invalid action!”; model output of step 7: “click [Buy Now]”, observation of step 7: “Your score (min 0.0, max 1.0): 1.0”, where the agent randomly clicks other buttons in Webshop website or generates empty responses before buying an item.

In one embodiment, as agent trajectories comprise scenarios when an agent interacts with complex environments such as websites, APIs, and tools. Such complexity can be heightened by the agent's capacity to communicate with other agents, navigate through diverse interfaces, and undertake tasks that require a sequence of interactions rather than single or limited exchanges. Thus, the challenge with agent trajectories extends to the evaluation of performance and quality. While some environments offer rewards as feedback for an agent's trajectory, such rewards are often tied to the task's final outcome rather than reflecting the quality of the trajectory itself. Consequently, a high reward does not necessarily indicate a flawless trajectory. For example, an agent might generate invalid actions during intermediate steps of a task. For instance, given a partial trajectory from an environment of an electronic commerce website: model output of step 4: “click [old world style]”, observation of step 4: “You have clicked old world style.”; model output of step 5: “click [rope sausage]”, observation of step 5: “Invalid action!”; model output of step 6: “ ”,observation of step 6: “Invalid action!”; model output of step 7: “click [Buy Now]”, observation of step 7: “Your score (min 0.0, max 1.0): 1.0”, where the agent randomly clicks other buttons in the e-commerce website or generates empty responses before buying an item.

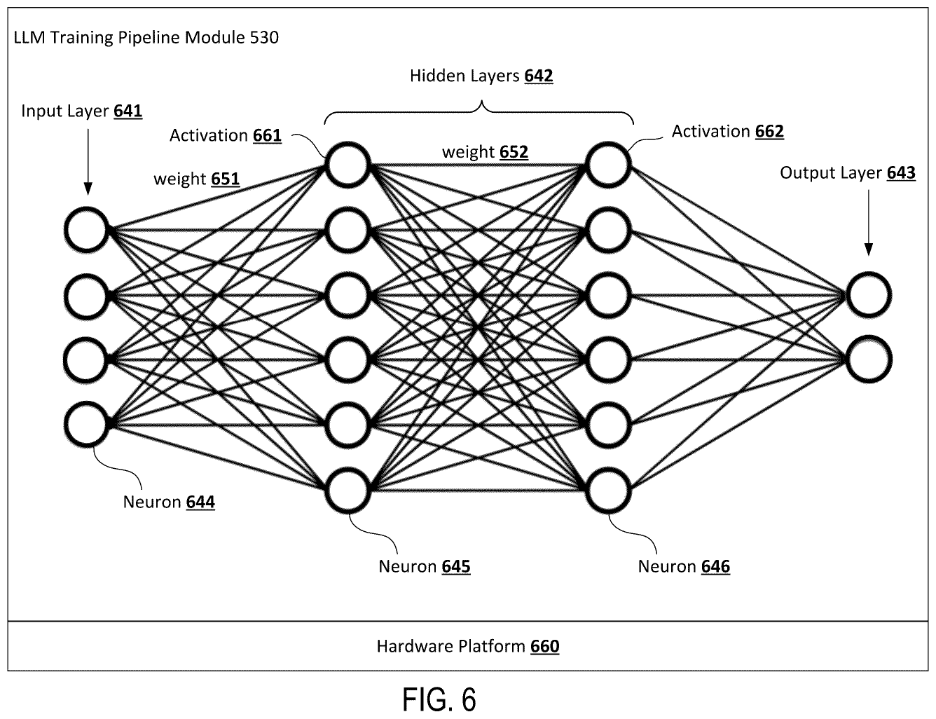

In view of the quality issues with agent trajectories, the Agent Rater 120 may receive and rate the standardized agent trajectory. In one embodiment, agent rater 120 may comprise a neural network model that is deployed and trained on a server (e.g., 730 in FIG. 7) using a training dataset of agent trajectory samples and annotated scores for each agent trajectory. Example training process may be described in relation to FIG. 6.

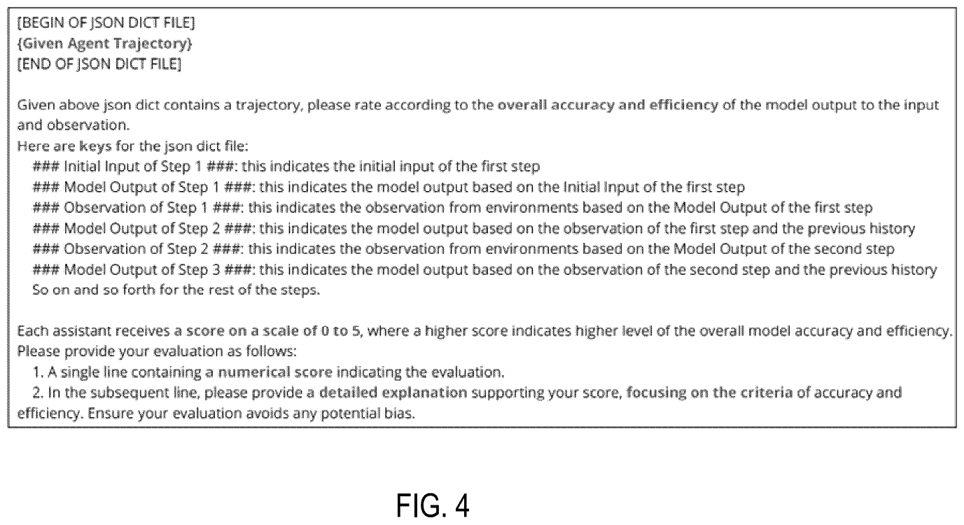

In one embodiment, agent rater 120 may adopt an external neural network model, such as a public LLM 121 such as Mistral, or a model API 122 such as ChatGPT, to perform the rating task. Unlike existing approaches that rate each triplet of (instruction, input, response) pair on general instruction data as there are usually single-turn or short conversations, agent rater 120 may rate the entire trajectory. For example, as shown in FIG. 4, an example input prompt may be used to include the agent trajectory, and then send to agent rater 120 to generate a rate the trajectory with a score 0-5 and an explanation, and they can be used to further develop better other rating models.

In one embodiment, the standardized agent trajectories with rating scores may be fed to a generator 130 to generate a training dataset. For example, generator 130 may comprise a combiner 131 to combine trajectories, a shuffler 132 to shuffle trajectories for random sampling, a customized filter 133 to filter trajectories with a lower than threshold rating score, an interleaver 134 to interleave trajectories, and/or the like.

In one embodiment, generator 130 may generate individual datasets by loading individual trajectories form agent rater 120. Then, for each dataset, the filter 133 may be applied to further customize the selection of data just before feeding it into the training framework. For instance, data trajectories with relatively low scores will be further evaluated and removed. This dataset may be randomly shuffled with controlled seeding to ensure randomness and reproducibility.

In one embodiment, multiple individual datasets may be combined, e.g., by employing an init.device.seed function to diversify the controlled seeds based on the process ID when data parallelism across multiple devices. For example, a balanced distribution of data may be obtained in the training dataset by partitioning, shuffling and interleaving data across devices while preserving randomness, thus enhancing the robustness and reproducibility of training.

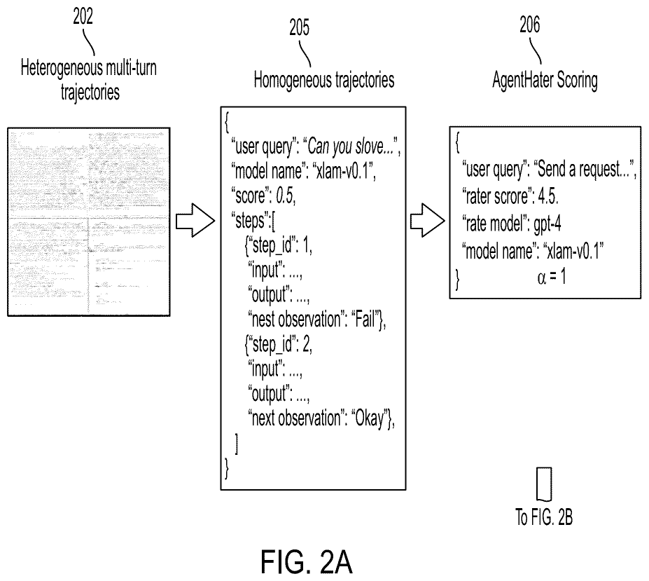

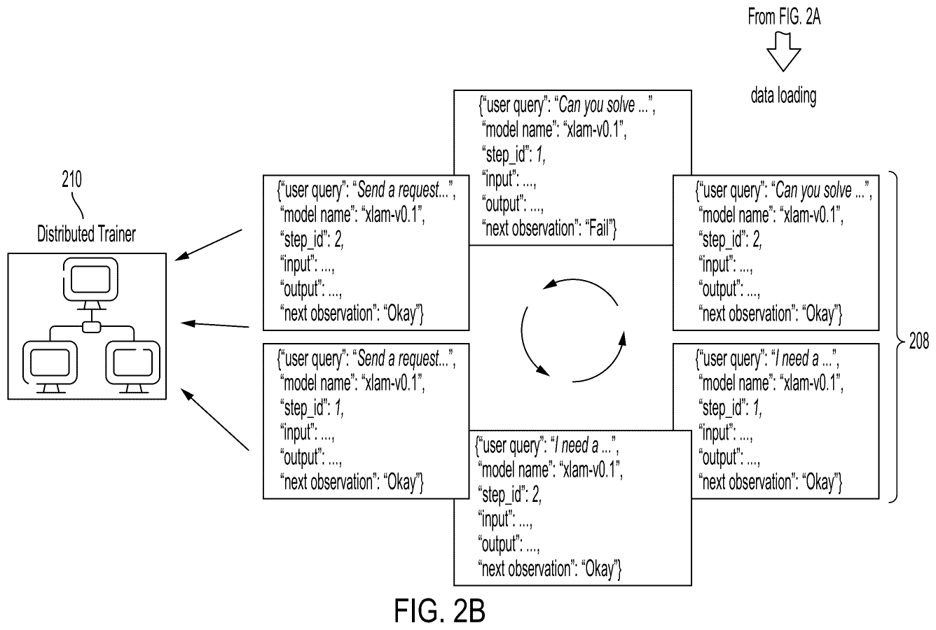

FIGS. 2A-2B provide a simplified diagram illustrating an example process of generating a training dataset for a hardware training platform of neural networks from heterogeneous multi-turn data, according to embodiments described herein. As illustrated in FIG. 2, heterogeneous multi-turn trajectories 202 may be converted to homogeneous trajectories 205. The conversion may be performed by parsing and extracting fields from heterogeneous multi-turn trajectories 202 and re-arranging the format according to format 205. In one implementation, the conversion may be performed by a neural network language model which receives an input of heterogeneous multi-turn trajectories 202 and generates an output of homogeneous trajectories 205.

In one embodiment, the homogeneous trajectories 205 may be given an agent rating score (e.g., by agent rater 120 in FIG. 1). The output of agent rater 120 may comprise a homogenous data format of “user query,” “rater score,” “rate model” and “model name” showing the model such as GPT-4.0 that generates the rating score for the homogeneous trajectories 205.

In one embodiment, homogeneous trajectories with agent rating scores 206 may then be loaded onto distributed trainers 210 for training one or more neural network models. Data loading process 208 may comprise combination, shuffling, filtering, interleaving data trajectories, as described in FIG. 1.

In one embodiment, distributed trainer 210 may comprise one or more hardware and/or software platform for training neural network models to perform different types of multi-turn agent tasks in different environments. For example, an agent model, such as a pre-trained Mixtral-8x7B-Instruct-v0.1 model (Jiang et al., 2024) may be trained or finetuned using the generated dataset from the data loading process 208. The distributed trainer 210 may be built on 8 Nvidia H100 GPUs, utilizing the QLoRA framework (Dettmers et al., 2023).

In one embodiment, during the training process, the agent model may be trained traversing each individual training dataset approximately 3 times on average. This multi-epoch training regimen facilitated comprehensive exposure to each individual dataset, enabling the model to effectively learn intricate patterns present in the training data.

FIGS. 3A-3B are example heterogeneous data records that are transformed into a homogeneous format as an agent trajectory, according to embodiments described herein. For instance, as shown in FIG. 3A, the trajectory 302 is taken from HotPotQA, which is a question answering dataset collected on the English Wikipedia, containing about 113K crowd-sourced questions that are constructed to require the introduction paragraphs of two Wikipedia articles to answer. Trajectory 302 consolidates the whole target trajectory into a single string under the prompt key. To process trajectory 302, data fields such as user query, Thought, Model Action: along with Env Observation: i for each step ith∈[1, N] may be parsed and retrieved from a single string.

In another example, as shown in FIG. 3B, ToolAIPaca is a framework that automatically generate a diverse tool-use corpus and learn generalized tool-use abilities on compact language models with minimal human intervention. Trajectory 304 from ToolAIpaca corpus may require the identification and matching of prompt inputs, model outputs, and observations at each step, followed by the accurate aggregation of trajectory history prior to proceeding to the next step.

For example, as shown in FIGS. 3A-3B, the transformation of trajectories from environments such as HotpotQA and ToolAIpaca may comprise the defined step structure 110a-c, where output aligns with the format specifications in the initial prompt input.

FIG. 4 is an example diagram illustrating an example prompt for an LLM to generate a rating given an input of agent trajectory, according to embodiments described herein. An example input prompt may be used to include the agent trajectory, and then send to agent rater 120 to generate a rate the trajectory with a score 0-5 and an explanation, and they can be used to further develop better other rating models.

### Computer and Network Environment

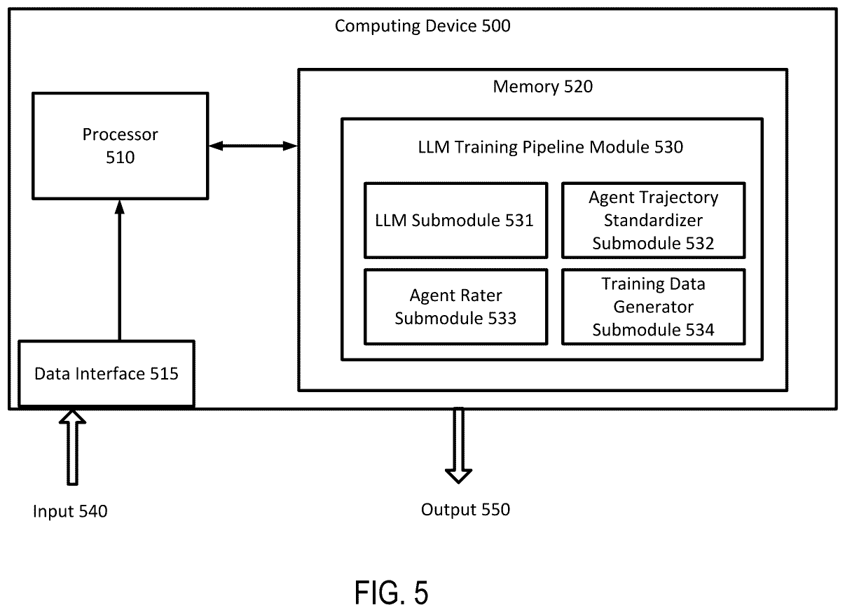

FIG. 5 is a simplified diagram illustrating a computing device implementing the unified LLM training pipeline described in FIGS. 1-4, according to one embodiment described herein. As shown in FIG. 5, computing device 500 includes a processor 510 coupled to memory 520. Operation of computing device 500 is controlled by processor 510. And although computing device 500 is shown with only one processor 510, it is understood that processor 510 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 500. Computing device 500 may be implemented as a stand-alone subsystem, as a board added to a computing device, and/or as a virtual machine.

Memory 520 may be used to store software executed by computing device 500 and/or one or more data structures used during operation of computing device 500. Memory 520 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 510 and/or memory 520 may be arranged in any suitable physical arrangement. In some embodiments, processor 510 and/or memory 520 may be implemented on a same board, in a same package (e.g., system-in-package), on a same chip (e.g., system-on-chip), and/or the like. In some embodiments, processor 510 and/or memory 520 may include distributed, virtualized, and/or containerized computing resources. Consistent with such embodiments, processor 510 and/or memory 520 may be located in one or more data centers and/or cloud computing facilities.

In some examples, memory 520 may include non-transitory, tangible, machine readable media that includes executable code that when run by one or more processors (e.g., processor 510) may cause the one or more processors to perform the methods described in further detail herein. For example, as shown, memory 520 includes instructions for LLM training pipeline module 530 that may be used to implement and/or emulate the systems and models, and/or to implement any of the methods described further herein. LLM training pipeline module 530 may receive input 540 such as an input text via the data interface 515 and generate an output 550 which may be a natural language processing task output.

The data interface 515 may comprise a communication interface, a user interface (such as a voice input interface, a graphical user interface, and/or the like). For example, the computing device 500 may receive the input 540 (such as a training text input) from a networked database via a communication interface. Or the computing device 500 may receive the input 540, such as a user utterance, from a user via the user interface.

In some embodiments, the LLM training pipeline module 530 is configured to train one or more LLMs using consolidated standardized data from multiple data sources. The LLM training pipeline module 530 may further include a LLM submodule 531, a data consolidation submodule 532, a large action submodule 533 and and/or the like.

Some examples of computing devices, such as computing device 500 may include non-transitory, tangible, machine readable media that include executable code that when run by one or more processors (e.g., processor 510) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 6 is a simplified diagram illustrating the neural network structure implementing the LLM training pipeline module 530 described in FIG. 5, according to some embodiments. In some embodiments, the LLM training pipeline module 330 and/or one or more of its submodules 631-435 may be implemented at least partially via an artificial neural network structure shown in FIG. 7. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 643. Each layer may comprise a plurality of neurons, and neurons between layers are interconnected according to a specific topology of the neural network topology. The input layer 641 receives the input data (e.g., 640 in FIG. 6A), such as an input image and an input text. The number of nodes (neurons) in the input layer 641 may be determined by the dimensionality of the input data (e.g., the length of a vector of a latent feature of the input image). Each node in the input layer represents a feature or attribute of the input.

The hidden layers 642 are intermediate layers between the input and output layers of a neural network. It is noted that two hidden layers 642 are shown in FIG. 6B for illustrative purpose only, and any number of hidden layers may be utilized in a neural network structure. Hidden layers 642 may extract and transform the input data through a series of weighted computations and activation functions.

For example, as discussed in FIG. 6, the LLM training pipeline module 530 receives an input 640 of an input image and transforms the input into an output 650 of an image representation. To perform the transformation, each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the LLM training pipeline module 530 and/or one or more of its submodules 631-335 may comprise the transformative neural network structure of layers of neurons, and weights and activation functions describing the non-linear transformation at each neuron. Such a neural network structure is often implemented on one or more hardware processors 610, such as a graphics processing unit (GPU). An example neural network may be a Transformer model, and/or the like.

In one embodiment, the LLM training pipeline module 330 and its submodules 631-335 may be implemented by hardware, software and/or a combination thereof. For example, the LLM training pipeline module 330 and its submodules 331-333 may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

In one embodiment, the neural network based LLM training pipeline module 330and one or more of its submodules 631-435 may be trained by iteratively updating the underlying parameters (e.g., weights 651, 652, etc., bias parameters and/or coefficients in the activation functions 661, 662 associated with neurons) of the neural network based on the loss. For example, during forward propagation, the training data such as a training image or a training text are fed into the neural network. The data flows through the network's layers 641, 642, with each layer performing computations based on its weights, biases, and activation functions until the output layer 643 produces the network's output 650. In some embodiments, output layer 643 produces an intermediate output on which the network's output 650 is based.

The output generated by the output layer 643 is compared to the expected output (e.g., a “ground-truth”) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

Parameters of the neural network are updated backwardly from the last layer to the input layer (backpropagating) based on the computed negative gradient using an optimization algorithm to minimize the loss. The backpropagation from the last layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as image animation.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in applications of intelligent agents.

FIG. 7 is a simplified block diagram of a networked system 700 suitable for implementing the LLM training pipeline framework described in FIGS. 1-4 and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive generated LLM outputs.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message indicating an LLM output from the server 730 and display the message via the UI application 712. In other embodiments, user device 710 may include additional or different modules having specialized hardware and/or software as required.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and IM applications that allow a user to send and receive emails, calls, texts, and other notifications through network 760. For example, the other application 716 may be an email or instant messaging application that receives a forecast result from the server 730. Other applications 716 may include device interfaces and other display modules that may receive input and/or output information. For example, other applications 716 may contain software programs for asset management, executable by a processor, including a graphical user interface (GUI) configured to provide an interface to the user 740 to view the visualized output.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets including training images/texts to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the LLM training pipeline module 330 and its submodules described in FIG. 4. In some implementations, LLM training pipeline module 330 may receive data from database 719 at the data vendor server 745 via the network 760 to generate an LLM output. The generated output may also be sent to the user device 710 for review by the user 740 via the network 760.

The database 732 may be stored in a transitory and/or non-transitory memory of the server 730. In one implementation, the database 732 may store data obtained from the data vendor server 745. In one implementation, the database 732 may store parameters of the LLM training pipeline module 530. In one implementation, the database 732 may store previously generated tensor vectors, and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

### Example Work Flow

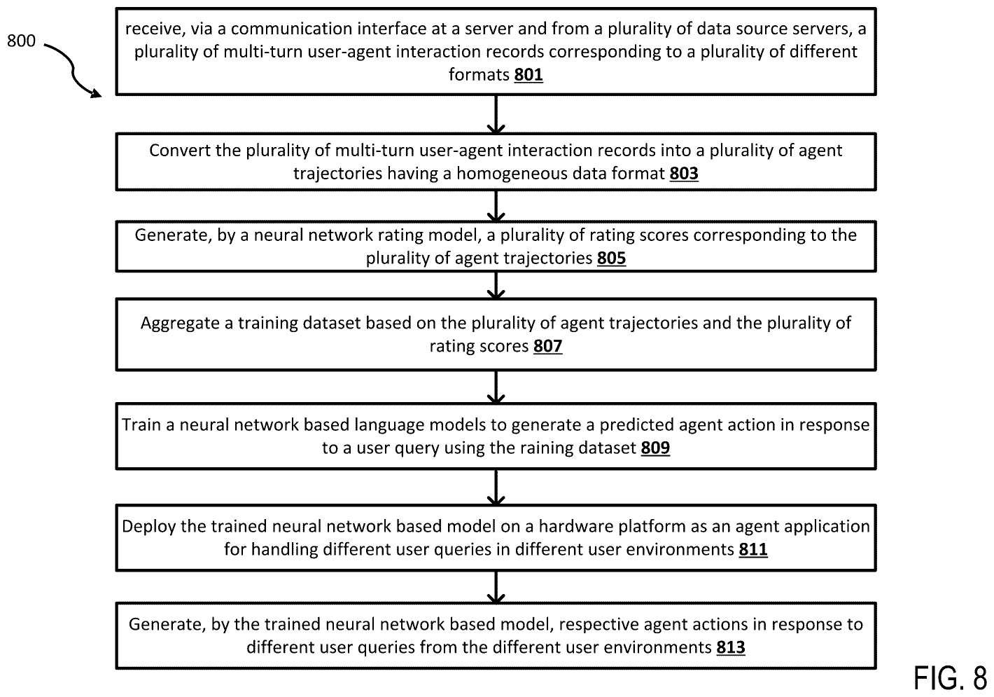

FIG. 8 is an example logic flow diagram illustrating an example method of training an intelligent agent for carrying out actions in response to user interactions, according to embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 600 corresponds to the operation of the LLM training pipeline module 530 (e.g., FIGS. 3 and 5).

As illustrated, the method 800 includes a number of enumerated steps, but aspects of the method 800 may include additional steps before, after, and in between the enumerated steps. In some aspects, one or more of the enumerated steps may be omitted or performed in a different order.

At step 801, a plurality of multi-turn user-agent interaction records (e.g., 202 in FIG. 2, 302, 304 in FIGS. 3A-3B) corresponding to a plurality of different formats may be received via a communication interface (e.g., 515 in FIG. 5, 733 in FIG. 7) at a server (e.g., 730 in FIG. 7) and from a plurality of data source servers (e.g., 745, 770, 780 in FIG. 7). For example, the received plurality of multi-turn user-agent interaction records comprise a first data format indicating a first user-agent interaction to complete a first type of task in a first environment, e.g., responding to an API call, etc., and a second data format indicating a second user-agent interaction to complete a second type of task in a second environment, e.g., responding to a customer service task, etc.

At step 803, the plurality of multi-turn user-agent interaction records may be converted into a plurality of agent trajectories having a homogeneous data format (e.g., 205 in FIG. 2). For example, a multi-turn user-agent interaction record may be parsed into a plurality of turns of interactions. For each turn of interactions, an interaction input indicating a context for the respective turn of interactions (e.g., “input” field), an interaction output indicating an agent action executed at the respective turn of interactions (e.g., “output” field) and an observation indicating a response from an environment at which the agent action is executed (e.g., “observation” field) may be extracted from the multi-turn user-agent interaction record. Turns of interaction inputs, interaction outputs and observations may be aggregated in the homogeneous data format.

In another implementation, a neural network based language model such as an LLM may be used to generate the plurality of agent trajectories using a prompt describing the homogeneous data format.

At step 805, a neural network rating model (e.g., agent rater 120 in FIG. 1) may generate a plurality of rating scores corresponding to the plurality of agent trajectories. For example, the neural network rating model is trained with a dataset of agent trajectories and annotated ratings. For example, the neural network rating model is a LLM external to the server and accessible via an application programming interface (API). A prompt input may be generated for the LLM, comprising at least one agent trajectory to be rated, and an instruction on evaluating the at least one agent trajectory.

At step 807, a training dataset may be aggregated based on the plurality of agent trajectories and the plurality of rating scores. The training dataset is aggregated by filtering agent trajectories having rating scores lower than a threshold and shuffling remaining agent trajectories randomly.

At step 809, a neural network based language model such as an agent model may be trained to generate a predicted agent action in response to a user query using the raining dataset.

At step 811, the trained neural network based model may be deployed on a hardware platform as an agent application for handling different user queries in different user environments. For example, the trained neural network based model may generate respective agent actions in response to different user queries from the different user environments.

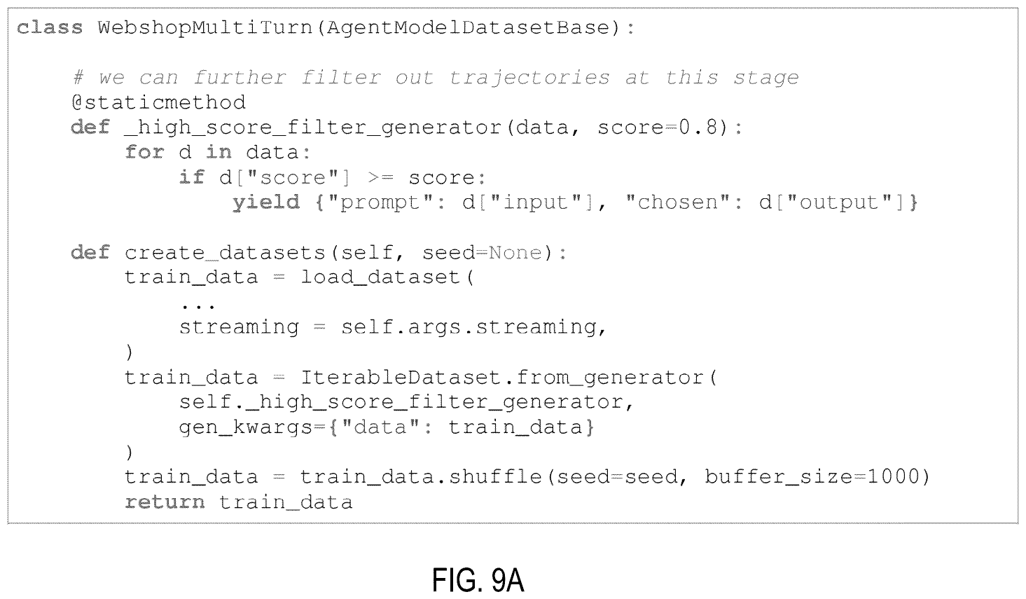

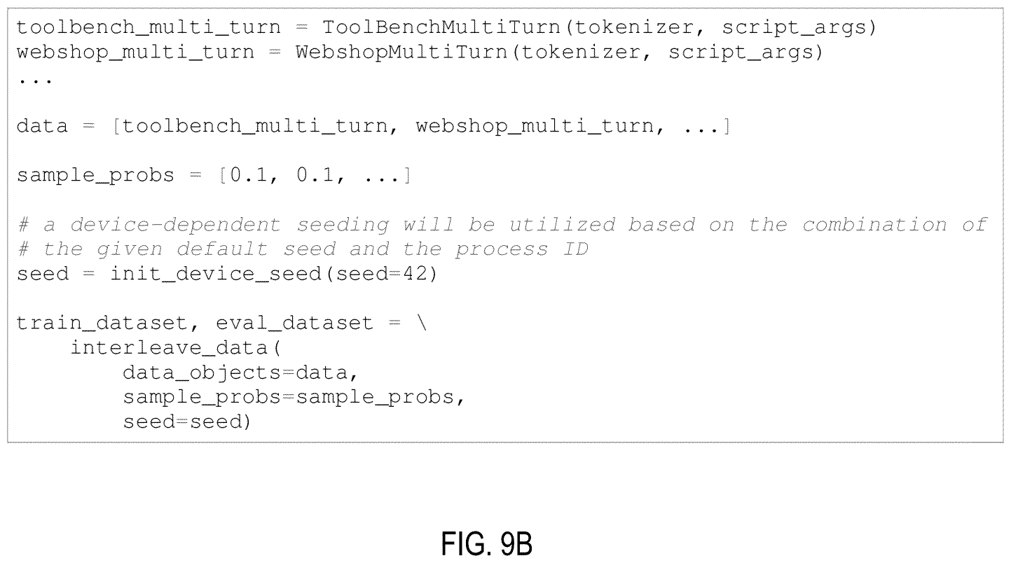

FIGS. 9A-9B are example diagrams illustrating example pseudo code segments for implementing the method shown in FIG. 8, according to embodiments described herein. For example, as shown in FIG. 9A, training data may be generated by the “filter” and “shuffling” functions as described in relation to FIG. 2. As shown in FIG. 9B, an interleave function may be performed to sample multi-turn data records.

### Example Data Performance

Experimental evaluations may be conducted across four benchmarks: Webshop (Yao et al., Webshop: Towards scalable real-world web interaction with grounded language agents, Advances in Neural Information Processing Systems, 35:20744-20757, 2022), HotpotQA (Yang et al., HotpotQA: A dataset for diverse, explainable multi-hop question answering, in Proceedings of Empirical Methods in Natural Language Processing (EMNLP), 2018), ToolEval and MINT-Bench (Wang et al., MINT: Evaluating LLMs in multi-turn interaction with tools and language feedback, arXiv preprint arXiv: 2309.10691, 2023). For example, Webshop creates an online shopping environment simulating product purchases, while HotpotQA involves multi-hop question-answering tasks requiring logical reasoning across Wikipedia passages via the Wikipedia API. The BOLAA's framework (Liu et al., 2023b), comprising five single-agent settings and a multi-agent scenario, may be adopted to evaluate model performance. For the Webshop benchmark, BOLAA comprises 900 user queries, of which we serve 200 as a test subset. For HotpotQA, 300 user questions are sampled into three difficulty levels-easy, medium, and hard-with each category containing 100 questions. These questions are exclusively reserved for model testing to ensure a rigorous evaluation process. Evaluation metrics may comprise an average reward for Webshop and F1 score for HotpotQA, to measure model performance. In Webshop, the reward metric assesses model accuracy based on the attributes overlapping between the purchased and the ground-truth items, while in HotpotQA, it quantifies the accuracy of agent-predicted answers against ground-truth responses.

In one embodiment, ToolEval is designed for real-time assessment of functional calling capabilities via RapidAPI, and GPT-4-0125-preview has been used as the evaluator. The evaluation employs the default depth-first search-based decision tree methodology, augmented by the Pass Rate metric to assess an LLM's ability to execute instructions, a fundamental criterion for optimal tool usage.

In one embodiment, MINT-Bench benchmark evaluates LLMs' ability to solve tasks with multi-turn interactions by using tools and leveraging natural language feedback. The benchmark focuses on reasoning, coding, and decision-making through a diverse set of established evaluation datasets, and carefully curate them into a compact subset for efficient evaluation. The benchmark asks LLMs to solve tasks with different interaction limits from 1 to 5 step and quantify LLMs' tool-augmented task-solving capability by absolute performance success rate, which measures the percentage of successful task instances as a function of interaction steps.

As shown in Table 1, the performance of agent model (referred to as xLAM-v0.1) trained using data loader loading training data 208 in FIG. 2 within the Webshop environment. The agent model consistently outperforms both GPT-3.5-Turbo and GPT-3.5-Turbo-Instruct across all agent configurations. Moreover, it surpasses GPT-4-0613 in five out of six settings, with the latter demonstrating superior planning capabilities but lower performance in reasoning, self-reflection, and multi-agent interactions.

TABLE 1
Average reward on the WebShop environment. Bold and Underline results
denote the best result and the second best result for each setting, respectively.

| | LAA Architecture | | | | | |
|---|---|---|---|---|---|---|
| LLM | ZS | ZST | ReAct | PlanAct | PlanReAct | BOLAA |
| Llama-2-70b-chat | 0.0089 | 0.0102 | 0.4273 | 0.2809 | 0.3966 | 0.4986 |
| Vicuna-33b | 0.1527 | 0.2122 | 0.1971 | 0.3766 | 0.4032 | 0.5618 |
| Mixtral-8x7B-Instruct-v0.1 | 0.4634 | 0.4592 | 0.5638 | 0.4738 | 0.3339 | 0.5342 |
| GPT-3.5-Turbo | 0.4851 | 0.5058 | 0.5047 | 0.4930 | 0.5436 | 0.6354 |
| GPT-3.5-Turbo-Instruct | 0.3785 | 0.4195 | 0.4377 | 0.3604 | 0.4851 | 0.5811 |
| GPT-4-0613 | 0.5002 | 0.4783 | 0.4616 | 0.7950 | 0.4635 | 0.6129 |
| xLAM-v0.1 | 0.5201 | 0.5268 | 0.6486 | 0.6573 | 0.6611 | 0.6556 |

As shown in Table 2, in the HotpotQA environment, the agent model trained using distributed trainer 210 in FIG. 2 (referred as “xLAM”) exhibits superior performance relative to GPT-3.5-Turbo and Mixtral-8x7B-Instruct-v0.1 across all settings.

TABLE 2
Average reward on the HotpotQA environment. Bold and
Underline results denote the best result
and the second best result for each setting, respectively.

| | LAA Architecture | | | | |
|---|---|---|---|---|---|
| LLM | ZS | ZST | ReAct | PlanAct | PlanReAct |
| Mixtral-8x7B- | 0.3912 | 0.3971 | 0.3714 | 0.3195 | 0.3039 |
| Instruct-v0.1 | | | | | |
| GPT-3.5-Turbo | 0.4196 | 0.3937 | 0.3868 | 0.4182 | 0.3960 |
| GPT-4-0613 | 0.5801 | 0.5709 | 0.6129 | 0.5778 | 0.5716 |
| xLAM-v0.1 | 0.5492 | 0.4776 | 0.5020 | 0.5583 | 0.5030 |

As shown in Table 3, the performance results on ToolEval show the agent model (referred to as “xLAM-v0.1”) surpasses both TooLlama V2 and GPT-3.5-Turbo-0125 across all evaluated scenarios, and outperforms GPT-4-0125-preview in two out of the three settings. This performance indicates xLAM-v0.1's superior capabilities in function calling and handling complex tool usage tasks.

TABLE 3
Pass Rate on ToolEval on three distinct scenarios. Bold and
Underline results denote the best result and
the second best result for each setting, respectively.

| | Unseen Insts | Unseen Tools | Unseen Tools |
|---|---|---|---|
| | & Same Set | & Seen Cat | &Unseen Cat |
| TooLlama V2 | 0.4385 | 0.4300 | 0.4350 |
| GPT-3.5-Turbo-0125 | 0.5000 | 0.5150 | 0.4900 |
| GPT-4-0125-preview | 0.5462 | 0.5450 | 0.5050 |
| xLAM-v0.1 | 0.5077 | 0.5650 | 0.5200 |

Table 4 presents the testing results on the challenging and comprehensive MINT-Bench, with baseline comparisons drawn from the official leaderboard. The agent model xLAM-v0.1 model secures the third rank in this rigorous benchmark, outperforming other agent-based models such as Lemur-70b-Chat-v1 and AgentLM-70b, as well as general large language models (LLMs) including Claude-2 and GPT-3.5-Turbo-0613. These results highlight the exceptional capability of our model to navigate the complexities of multi-turn interactions and task resolution.

TABLE 4
Testing results on MINT-Bench with different
interaction limits from 1 to 5 step.

| | 1-step | 2-step | 3-step | 4-step | 5-step |
|---|---|---|---|---|---|
| GPT-4-0613 | nan | nan | nan | nan | 69.45 |
| Claude-Instant-1 | 12.12 | 32.25 | 39.25 | 44.37 | 45.90 |
| xLAM-v0.1 | 4.10 | 28.50 | 36.01 | 42.66 | 43.96 |
| Claude-2 | 26.45 | 35.49 | 36.01 | 39.76 | 39.93 |
| Lemur-70b-Chat-v1 | 3.75 | 26.96 | 35.67 | 37.54 | 37.03 |
| GPT-3.5-Turbo-0613 | 2.73 | 16.89 | 24.06 | 31.74 | 36.18 |
| AgentLM-70b | 6.48 | 17.75 | 24.91 | 28.16 | 28.67 |
| CodeLlama-34b | 0.17 | 16.21 | 23.04 | 25.94 | 28.16 |
| Llama-2-70b-chat | 4.27 | 14.33 | 15.70 | 16.55 | 17.92 |

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of training an intelligent agent for carrying out actions in response to user interactions, the method comprising:
receiving, via a communication interface at a server and from a plurality of data source servers, a plurality of multi-turn user-agent interaction records corresponding to a plurality of different formats;
converting the plurality of multi-turn user-agent interaction records into a plurality of agent trajectories having a homogeneous data format;
generating, by a neural network rating model, a plurality of rating scores corresponding to the plurality of agent trajectories;
aggregating a training dataset based on the plurality of agent trajectories and the plurality of rating scores;
training a neural network based language models to generate a predicted agent action in response to a user query using the raining dataset; and
deploying the trained neural network based model on a hardware platform as an agent application for handling different user queries in different user environments.

2. The method of claim 1, wherein the received plurality of multi-turn user-agent interaction records comprise a first data format indicating a first user-agent interaction to complete a first type of task in a first environment and a second data format indicating a second user-agent interaction to complete a second type of task in a second environment.

3. The method of claim 1, wherein the converting the plurality of multi-turn user-agent interaction records into the plurality of agent trajectories having the homogeneous data format comprises:
parsing a multi-turn user-agent interaction record into a plurality of turns of interactions;
extracting, for each turn of interactions, an interaction input indicating a context for the respective turn of interactions, an interaction output indicating an agent action executed at the respective turn of interactions and an observation indicating a response from an environment at which the agent action is executed, from the multi-turn user-agent interaction record;
aggregating turns of interaction inputs, interaction outputs and observations in the homogeneous data format.

4. The method of claim 1, wherein the converting the plurality of multi-turn user-agent interaction records into the plurality of agent trajectories having the homogeneous data format comprises:
generating, by a neural network based language model, the plurality of agent trajectories using a prompt describing the homogeneous data format.

5. The method of claim 1, wherein the neural network rating model is trained with a dataset of agent trajectories and annotated ratings.

6. The method of claim 1, wherein the neural network rating model is a large language model external to the server and accessible via an application programming interface (API), and wherein the generating, by the neural network rating model, the plurality of rating scores comprises:
generating a prompt input for the large language model, comprising at least one agent trajectory to be rated, and an instruction on evaluating the at least one agent trajectory.

7. The method of claim 1, wherein the training dataset is aggregated by filtering agent trajectories having rating scores lower than a threshold and shuffling remaining agent trajectories randomly.

8. The method of claim 1, wherein the training dataset comprises agent trajectories originated in different environments from the different data sources.

9. The method of claim 1, further comprising:
generating, by the trained neural network based model, respective agent actions in response to different user queries from the different user environments.

10. A system of training an intelligent agent for carrying out actions in response to user interactions, the system comprising:
a communication interface receiving, at a server and from a plurality of data source servers, a plurality of multi-turn user-agent interaction records corresponding to a plurality of different formats;
a memory storing a plurality of processor-executable instructions; and
one or more processors executing the plurality of processor-executable instructions to perform operations comprising:
converting the plurality of multi-turn user-agent interaction records into a plurality of agent trajectories having a homogeneous data format;
generating, by a neural network rating model, a plurality of rating scores corresponding to the plurality of agent trajectories;
aggregating a training dataset based on the plurality of agent trajectories and the plurality of rating scores;
training a neural network based language models to generate a predicted agent action in response to a user query using the raining dataset; and
deploying the trained neural network based model on a hardware platform as an agent application for handling different user queries in different user environments.

11. The system of claim 10, wherein the received plurality of multi-turn user-agent interaction records comprise a first data format indicating a first user-agent interaction to complete a first type of task in a first environment and a second data format indicating a second user-agent interaction to complete a second type of task in a second environment.

12. The system of claim 10, wherein the operation of converting the plurality of multi-turn user-agent interaction records into the plurality of agent trajectories having the homogeneous data format comprises:
parsing a multi-turn user-agent interaction record into a plurality of turns of interactions;
extracting, for each turn of interactions, an interaction input indicating a context for the respective turn of interactions, an interaction output indicating an agent action executed at the respective turn of interactions and an observation indicating a response from an environment at which the agent action is executed, from the multi-turn user-agent interaction record;
aggregating turns of interaction inputs, interaction outputs and observations in the homogeneous data format.

13. The system of claim 10, wherein the operation of converting the plurality of multi-turn user-agent interaction records into the plurality of agent trajectories having the homogeneous data format comprises:
generating, by a neural network based language model, the plurality of agent trajectories using a prompt describing the homogeneous data format.

14. The system of claim 10, wherein the neural network rating model is trained with a dataset of agent trajectories and annotated ratings.

15. The system of claim 10, wherein the neural network rating model is a large language model external to the server and accessible via an application programming interface (API), and wherein the operation of generating, by the neural network rating model, the plurality of rating scores comprises:
generating a prompt input for the large language model, comprising at least one agent trajectory to be rated, and an instruction on evaluating the at least one agent trajectory.

16. The system of claim 10, wherein the training dataset is aggregated by filtering agent trajectories having rating scores lower than a threshold and shuffling remaining agent trajectories randomly.

17. The system of claim 10, wherein the training dataset comprises agent trajectories originated in different environments from the different data sources.

18. The system of claim 10, wherein the operations further comprise:
generating, by the trained neural network based model, respective agent actions in response to different user queries from the different user environments.

19. A non-transitory processor-readable storage medium storing a plurality of processor-executable instructions for training an intelligent agent for carrying out actions in response to user interactions, the instructions being executed by one or more processors to perform operations comprising:
receiving, via a communication interface at a server and from a plurality of data source servers, a plurality of multi-turn user-agent interaction records corresponding to a plurality of different formats;
converting the plurality of multi-turn user-agent interaction records into a plurality of agent trajectories having a homogeneous data format;
generating, by a neural network rating model, a plurality of rating scores corresponding to the plurality of agent trajectories;
aggregating a training dataset based on the plurality of agent trajectories and the plurality of rating scores;
training a neural network based language models to generate a predicted agent action in response to a user query using the raining dataset; and
deploying the trained neural network based model on a hardware platform as an agent application for handling different user queries in different user environments.

20. The non-transitory processor-readable storage medium of claim 19, wherein the operation of converting the plurality of multi-turn user-agent interaction records into the plurality of agent trajectories having the homogeneous data format comprises:
parsing a multi-turn user-agent interaction record into a plurality of turns of interactions;
extracting, for each turn of interactions, an interaction input indicating a context for the respective turn of interactions, an interaction output indicating an agent action executed at the respective turn of interactions and an observation indicating a response from an environment at which the agent action is executed, from the multi-turn user-agent interaction record;
aggregating turns of interaction inputs, interaction outputs and observations in the homogeneous data format.
